(19) United States
(12) Patent Application Publication
(10) Pub. No.: US 2009/0096734 A1
(43) Pub. Date: Apr. 16, 2009

(54) LIQUID CRYSTAL DISPLAY AND METHOD OF DRIVING THE SAME

(75) Inventors: Chien-Chih HUANG, Tainan County (TW); Chung-Kuang WEI, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 12/108,561

(22) Filed: Apr. 24, 2008

(30) Foreign Application Priority Data
Oct. 12, 2007 (TW) 096138170

(51) Int. Cl. G09G 3/36

(52) U.S. Cl. 345/89

(57) ABSTRACT

A method of driving a liquid crystal display apparatus is provided. Each pixel of the liquid crystal display apparatus has a first sub-pixel and a second sub-pixel. The method of driving the liquid crystal display apparatus includes receiving a selecting signal and then deciding the display mode of the liquid crystal display apparatus. When the liquid crystal display apparatus is in a normal display mode, the second sub-pixels are deactivated. When the liquid crystal display apparatus is on a restricted view-angle display mode, some of the second sub-pixels are chosen and activated.

### BACKGROUND

1. Technical Field

The disclosure generally relates to a liquid crystal display (LCD) apparatus and a method of driving the same, and particularly, to an anti-peep LCD apparatus and a method of driving the same.

2. Description of Related Art

Mostly benefited from the breakthrough progress of semiconductor components and display apparatus, multimedia technologies are drastically and rapidly developing. Thin film transistor liquid crystal display (TFT-LCD) apparatus with advantages of high display quality, good space utilization, low power consumption, none radiation is gradually becoming the mainstream of the display market.

The appearances of the LCD apparatuses are desired to be faddish, light, slim, and easy to carry. On the other hand, the LCD apparatuses are also demanded for better characteristics and performance, like high contrast ratio, no gray scale inversion, low color shift, high luminance, high color richness, high color saturation, rapid response, and wide viewing angle. There are several technologies for achieving a wide viewing angle, including twisted nematic liquid crystal plus wide viewing film, in-plane switching LCD apparatus, fringe filed switching LCD apparatus and multi-domain vertically alignment (MVA) LCD apparatus.

Taking a conventional wide viewing angle LCD apparatus as an example, when it is viewed from the front or at an angle, images displayed on the LCD apparatus can be viewed by any viewer. However, being portable, LCD apparatuses are often carried out and frequently operated in public sites. When such an LCD apparatus is used by a user in a public site for reading private or secret emails or information, the wide viewing angle is not desirable any more because of the undesired privacy loss when others peep at the LCD.

FIG. 1A is a schematic diagram illustrating a conventional anti-peep LCD apparatus. As shown in FIG. 1A, the anti-peep LCD apparatus 10 includes a viewing angle switching unit 12 disposed under an LCD panel 11. The viewing angle switching unit 12 includes two glass substrates 12a, 12b, and a liquid crystal layer 12c. When the viewing angle switching unit 12 is not activated, there is no voltage difference existing between the two glass substrates 12a, 12b, so that long axes of liquid crystal molecules of the liquid crystal layer 12c are substantially parallel with surfaces of the glass substrates 12a, 12b. Thus, viewers viewing from the front or at an angle can see images displayed on the LCD apparatus 10. However, when the viewing angle switching unit 12 is activated, there is a voltage difference applied between the two glass substrates 12a, 12b, such that the liquid crystal molecules of the liquid crystal layer 12c become twisted. In this way, those viewing from the front can view the images displayed as normal. However, those viewers viewing at an angle cannot view the images as accurate as that displayed.

Such an anti-peep LCD apparatus introduces a pair of glass substrates to an ordinary LCD apparatus with higher cost. Further, the viewing angle switching unit 12 only makes the images displayed darker to the side viewers. The profiles of the images may still be viewed by those side viewers.

FIG. 1B is a schematic diagram illustrating another conventional anti-peep LCD apparatus. Referring to FIG. 1B, each pixel 20 of the anti-peep LCD apparatus has two sub-pixels 22 and 24, and the liquid crystal molecules disposed in the two sub-pixels 22 and 24 correspondingly are tilted in different directions. The light leakage by the tilt of the liquid crystal molecules in the sub-pixel 24 disturbs the images displayed by the LCD apparatus, and the side viewers will be incapable of viewing the accurate images. However, the light leakage makes the images brighter while the side viewers can still, to some degree, identify profiles of the images.

FIG. 1C is a schematic diagram illustrating still another conventional anti-peep LCD apparatus. Referring to FIG. 1C, each pixel 30 of the LCD apparatus includes two sub-pixels 32, 34, and the thicknesses of the liquid crystal layer of the sub-pixels 32, 34 are different. Thus, a phase retardation of the sub-pixel 32 is greater than that of the sub-pixel 34. Side viewers view brighter images because of the light leakage caused by the tilt of the liquid crystal molecules in the sub-pixel 34. However, the fabrication for this kind of LCD apparatus is too complex, and side viewers can still, to some degree, identify the profiles of the images.

### SUMMARY

An embodiment of the present invention provides a method of driving an LCD apparatus. The LCD apparatus includes a plurality of pixels, each pixel including a first sub-pixel and a second sub-pixel. The method of driving the LCD apparatus includes receiving a selecting signal, and determining that the LCD apparatus is working in a narrow viewing angle display mode or a normal display mode. When the LCD apparatus is determined to be working in the normal display mode, the first sub-pixels are driven to display images, and at the same time the second sub-pixels are set in a dark status. When the LCD apparatus is determined to be working in the narrow viewing angle display mode, the first sub-pixels are driven to display images, and at the same time some of the second sub-pixels are selected and driven to work in a bright status.

A further embodiment of the present invention provides an LCD apparatus. The LCD apparatus includes an active device array substrate, an opposite substrate, a liquid crystal layer, and two polarizers. The active device array substrate includes a substrate, and a plurality of scan lines, data lines, and pixels disposed on the substrate. Each pixel includes a first sub-pixel and a second sub-pixel. Each first sub-pixel includes a first active device and a first sub-pixel electrode electrically connected together. Each second sub-pixel includes at least one second sub-pixel electrode, and at least one second active device disposed on the active device array substrate. The second active device and the second sub-pixel electrode of the second sub-pixel are electrically connected together. The opposite substrate is disposed over the active device array substrate. The liquid crystal layer is disposed between the active device array substrate and the opposite substrate. The liquid crystal layer includes liquid crystal molecules. The polarizers are disposed respectively on the active device array substrate and the opposite substrate. Each polarizer has a transmission axis, and the two transmission axes of the two polarizers are perpendicular with one another. When the LCD apparatus is driven in a narrow viewing angle display mode, a control unit selects some of the second sub-pixels to be driven to work in a bright status, in which the liquid crystal molecules located in the selected second sub-pixels tilt in a direction parallel with one of the transmission axes of the polarizers.

A further embodiment of the present invention provides a method of driving an LCD apparatus. The LCD apparatus comprises a plurality of pixels, each comprising a first sub-pixel and a second sub-pixel. The method comprises: receiving a selecting signal determining the LCD apparatus to work in a narrow viewing angle display mode or a normal display mode; when the LCD apparatus is determined to work in the normal display mode, driving the first sub-pixels to display images, and at the same time deactivating the second sub-pixels; and when the LCD apparatus is determined to work in the narrow viewing angle display mode, driving the first sub-pixels to display images, and at the same time selectively activating some, not all, of the second sub-pixels. An LCD apparatus implementing the method is also provided in accordance with another embodiment.

The present invention achieves the objective of anti-peep by selectively activating the second sub-pixels and disturbing the images displayed by the first sub-pixels when viewing from a side viewing angle.

### BRIEF DESCRIPTION OF THE DRAWINGS

The accompanying drawings are included to provide a further understanding of embodiments of the invention, and are incorporated in and constitute a part of this specification. The drawings illustrate embodiments of the invention and, together with the description, serve to explain the principles of such embodiments of the invention.

FIGS. 1A through 1C are schematic diagrams illustrating three kinds of different conventional anti-peep LCD apparatuses.

FIG. 2A is a top view of an active device array substrate of an LCD apparatus according to a first embodiment of the present invention.

FIG. 2B is an isometric view of a single pixel of the active device array substrate shown in FIG. 2A.

FIG. 2C is a view similar to FIG. 2A and showing further features in accordance with an embodiment of the invention.

FIG. 3A is a partially enlarged view of FIG. 2A.

FIG. 3B is a schematic diagram illustrating a transmission axis of a polarizer and a tilting direction of liquid crystal molecules.

FIG. 4A illustrates the arrangement of liquid crystal molecules located in the second sub-pixel when there is no voltage applied to the liquid crystal layer shown in FIG. 2B.

FIG. 4B illustrates the tilting direction of the liquid crystal molecules of the single second sub-pixel shown in FIG. 2B when a control voltage is applied to the LCD apparatus.

FIG. 5 is a flow chart describing steps of a method of driving the LCD apparatus according to an embodiment of the present invention.

FIG. 6A illustrates a normal image displayed by the LCD apparatus.

FIG. 6B illustrates the image viewed by the viewer when all second sub-pixels are in a bright status.

FIG. 6C illustrates the image viewed by the viewer when some of the second sub-pixels are in the bright status.

FIG. 7 is a schematic diagram illustrating the LCD apparatus being partitioned into a plurality of first regions and a plurality of second regions which are alternately arranged.

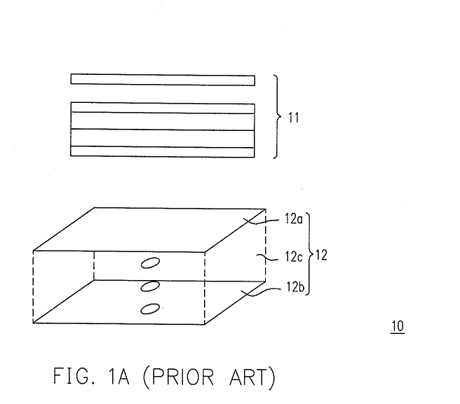

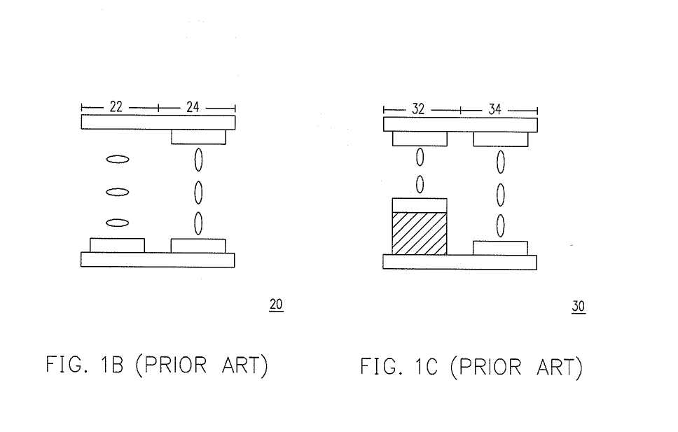

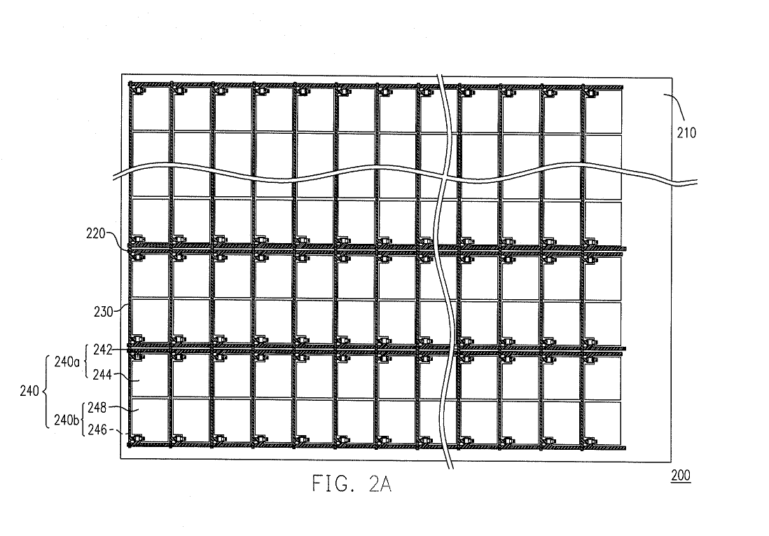

### DESCRIPTION OF EMBODIMENTS

Reference will now be made in detail to embodiments of the invention, examples of which are illustrated in the accompanying drawings. Wherever possible, the same reference numbers are used in the drawings and the description to refer to the same or like parts.

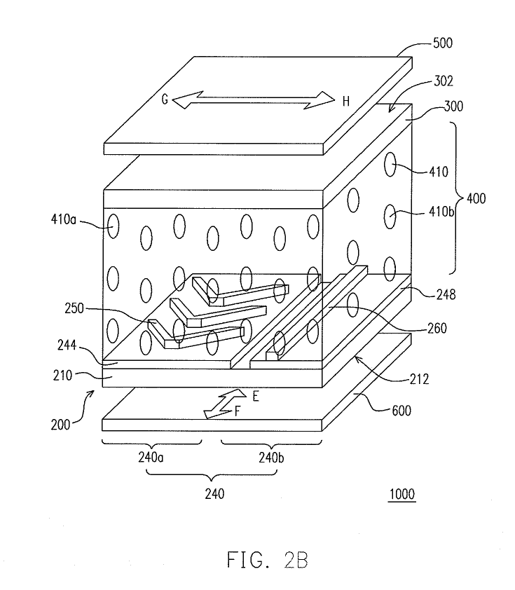

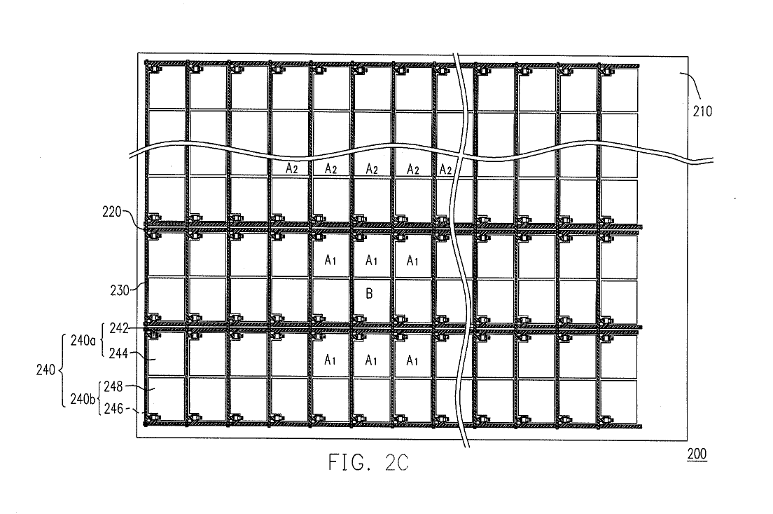

FIG. 2A is a top view of an active device array substrate of an LCD apparatus according to a first embodiment of the present invention. FIG. 2B is an isometric view of a single pixel of the active device array substrate shown in FIG. 2A. Referring to FIGS. 2A and 2B together, there is shown an LCD apparatus 1000 which can be either a single cell gap LCD apparatus or a dual cell gap LCD apparatus. The LCD apparatus 1000 includes a plurality of pixels 240. Each pixel 240 includes a first sub-pixel 240a, and a second sub-pixel 240b. The LCD apparatus 1000 includes an active device array substrate 200, an opposite substrate 300, a liquid crystal layer 400, and two polarizers 500, 600.

The active device array substrate 200 includes a substrate 210, and a plurality of scan lines 220, data lines 230, first sub-pixels 240a, and second sub-pixels 240b, wherein the scan lines 220, the data lines 230, the first sub-pixels 240a, and the second sub-pixels 240b are disposed on the substrate 210. The first sub-pixels 240a, the second sub-pixels 240b are correspondingly electrically connected to the scan lines 220 and the data lines 230. Each of the first sub-pixels 240a includes a first active device 242, and a first sub-pixel electrode 244. The first active device 242 and the first sub-pixel electrode 244 are electrically connected together. According to an aspect of the embodiment, each of the second sub-pixels 240b includes a second active device 246 and a second sub-pixel electrode 248. The second active device 246 and the second sub-pixel electrode 248 of the second sub-pixel 240b are electrically connected together. According to another aspect of the embodiment, there is only one second active device 246 disposed on the active device array substrate 200, and all second sub-pixel electrodes 248 are electrically connected to the second active device. There may also be several second active devices 246 each for a number of second sub-pixels 240b (e.g., in a row or column), of which the respective sub-pixel electrodes 248 are electrically connected to and driven by the common second active device 246.

The above first active device 242 and the second active device 246 are all TFTs. Alternatively, the first active devices 242 are TFTs, while the second active devices 246 are diodes or other active devices. Further, an area of the first sub-pixel 240a can be equal to or different from that of the second sub-pixel 240b.

The opposite substrate 300 is disposed on the active device array substrate 200. According to an embodiment of the present invention, the opposite substrate 300 is a color filter. According to another aspect of the embodiment, the color filter may be replaced by disposing a plurality of color filtering films on the active device array substrate 200, while the opposite substrate can be replaced with a glass substrate.

The liquid crystal layer 400 is disposed between the active device array substrate 200 and the opposite substrate 300. The liquid crystal layer 400 includes a plurality of liquid crystal molecules. For illustration convenience, the liquid crystal molecules are denoted as liquid crystal molecules 410a and 410b according to its location being in the first sub-pixel 240a or the second sub-pixel 240b.

The polarizers 500, 600 are disposed respectively on surfaces 212, 302 of the active device array substrate 200 and the opposite substrate 300, away from the liquid crystal layer 400. Each of the two polarizers has a light transmission axis, EF and GH, respectively, and the two light transmission axes are perpendicular to each other.

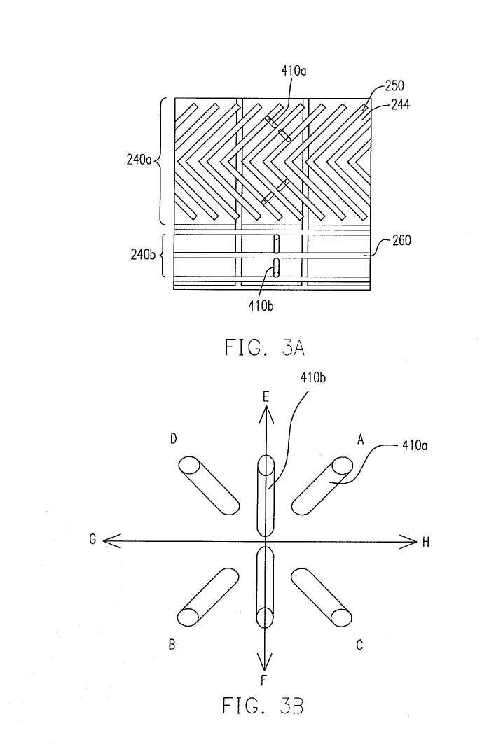

FIG. 3A is a partially enlarged view of FIG. 2A. Referring to FIGS. 2B and 3A together, the active device array substrate 200 includes a first regional partition structure 250 which is neither conductive nor formed as an integral part of the first sub-pixel electrode 244, and which is configured in each of the first sub-pixels 240a. The first regional partition structure 250 shown in FIG. 2B is, for example, an arrow type strip protrusion. According to an aspect of the embodiment, the first regional partition structure can also include (a) slits (not shown) formed in predetermined patterns in the first sub-pixel electrode 244 or (b) patterned alignment films formed on the first sub-pixel electrode FIG. 3B is a schematic diagram illustrating a transmission axis of a polarizer and a tilting direction of liquid crystal molecules. For clearer illustration, FIG. 3B describes the light transmission axes of the polarizers and the liquid crystal molecules only. As shown in FIG. 3B, according to the first region partition structure 250, the liquid crystal molecules 410a can be tilted toward four preset tilting directions A, B, C and D.

In order to further restrict a range of the viewing angle of the LCD apparatus 1000, the LCD apparatus 1000 may further includes a second regional partition structure 260 disposed on the second sub-pixel electrode 248. The second regional partition structure 260, for example, is a strip shaped protrusion. Due to the second regional partition structure 260, the liquid crystal molecules 410b achieve different alignment directions other than A, B, C, and D. As shown in FIG. 3B, the liquid crystal molecules 410b can be tilted with preset tilting directions E and F. According to an aspect of the embodiment, the second regional partition structure can also include slits formed in the second sub-pixel electrode or patterned alignment films formed on the second sub-pixel electrode.

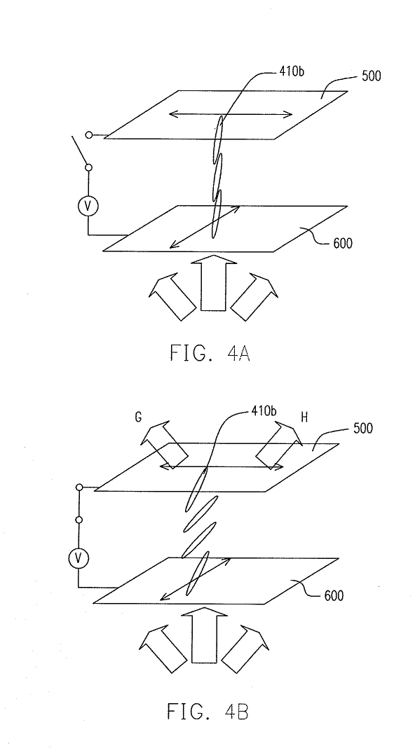

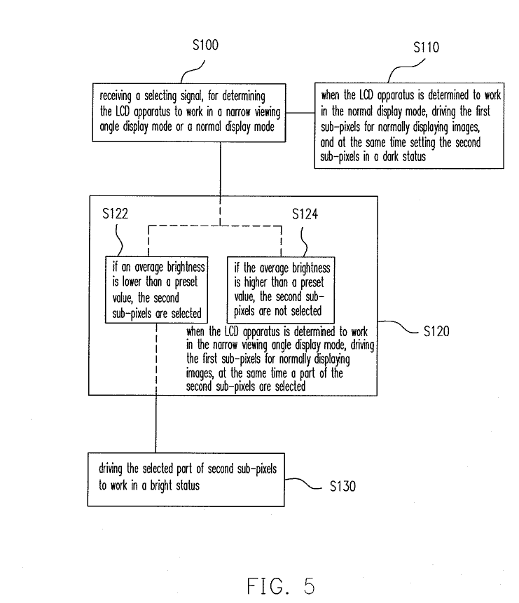

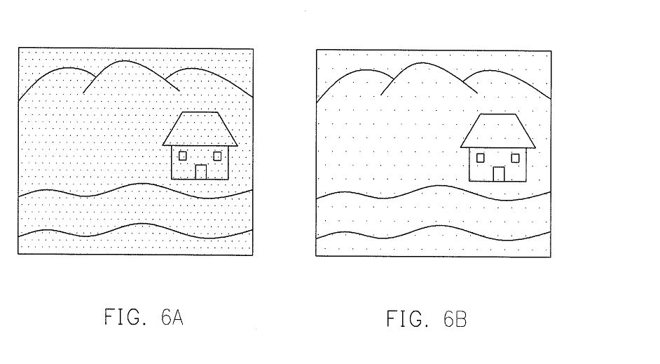

FIG. 4A illustrates the arrangement of liquid crystal molecules of the second sub-pixel when there is no voltage applied to the liquid crystal layer. For clearer illustration, similar to FIG. 3B, FIG. 4A describes the light transmission axes of the polarizers and the liquid crystal molecules only. FIG. 5 is a flow chart describing steps of a method of driving the LCD apparatus according to an embodiment of the present invention. The method can be performed by a control unit (not shown) of the LCD apparatus or an external controller (not shown). Please refer to FIGS. 2B, 3B, 4A and 5 together.

When the LCD apparatus 1000 is not driven, long axes of the liquid crystal molecules 410a of the first sub-pixels 210a, and long axes of the liquid crystal molecules 410b of the second sub-pixels 210b extend along a direction substantially perpendicular with a surface 212 of the substrate 210. Thus, when light passes through the polarizer 600 (upwardly from bottom of FIG. 2B), the polarized light component whose direction does not coincide with the light transmission axis EF of the polarizer 600 is absorbed, and only the light component whose direction coincides with the light transmission axis EF is incident upon the liquid crystal molecules 410. The liquid crystal molecules 410 are not yet tilted, and therefore light passing through the liquid crystal molecules 410 retains the polarizing direction EF. Finally, when passing through the polarizer 500, because the light transmission axis GH of the polarizer 500 is perpendicular with the light transmission axis EF of the polarizer 600, the polarized light component whose direction coincides with the light transmission axis EF of the polarizer 600 will be absorbed by the polarizer 500 and will not be outputted from the LCD apparatus 1000. As such, in this case, the first sub-pixels 210a are in a dark status.

When the LCD apparatus 1000 is driven, the LCD apparatus 1000 receives a selecting signal. The selecting signal determines the LCD apparatus to work in a narrow viewing angle display mode or in a normal display mode, as shown in step S100.

The selecting signal according to an embodiment of the present invention can be input by the user, attached to an image signal, generated according to a power supply status of the LCD apparatus 1000 or according to a sensing result of ambient factors. In particular, when the user notes that the content to be displayed next is private or confidential, he may manually press a key or otherwise instruct the LCD apparatus via software to display in the narrow viewing angle display mode. Alternatively, the instruction for instructing the LCD apparatus 1000 to display in the narrow viewing angle display mode can also be attached to an image signal. When the user actives the image signal having such instruction attached thereto, the LCD apparatus automatically switches to the narrow viewing angle display mode. According to another aspect of the embodiment, a sensing result of ambient factors, e.g., ambient luminance, can also be relied upon to determine whether to select the narrow viewing angle display mode. Further, an automatically detected power supply status of the LCD apparatus may also be relied upon for determining whether to select the narrow viewing angle display mode. For example, when it is detected that the LCD apparatus 1000 is being powered by a battery, the narrow viewing angle display mode is automatically disabled, and when it is detected that the power supply to the LCD apparatus 1000 is changed to an external power source, the narrow viewing angle display mode is automatically enabled.

As shown in step S110, when the LCD apparatus 1000 is selected to display in the normal mode, the first sub-pixels 2100 are driven to normally display images, and at the same time, the second sub-pixels 2200 are driven to work in the dark status. In particular, when the LCD apparatus 1000 is being driven, a driving voltage applied to the first sub-pixels 240a tilts the liquid crystal molecules 410a toward four directions A, B, C, and D, so as to allow light to transmit therethrough, and the first sub-pixels are working in the bright status. Meanwhile, liquid crystal molecules 410b in the second sub-pixels 240b are not tilted, since there is no voltage applied thereupon, so that light cannot transmit therethrough, and the second sub-pixels are working in the dark status. Thus, images displayed by the LCD apparatus 1000 in a normal display mode can be viewed by viewers from the front or at an angle. It should be noted that the dark status is defined as a status in that light is substantially incapable of transmitting through liquid crystal molecules, and the bright status is defined as a status in that light is capable of transmitting through the liquid crystal molecules.

As shown in step S120, when the LCD apparatus is selected to display with the narrow viewing angle display mode, the first sub-pixels 240a are driven to display normal images, and at the same time, at least one, some or all of second sub-pixels 240b are selected.

According to an embodiment, the second sub-pixels 240b are selected according to an average brightness of first sub-pixels 240a which are correspondingly adjacent to each second sub-pixel 240b. For example, as can be seen in FIG. 2C which is a view similar to FIG. 2A, a second sub-pixel 240b at B is selected according to an average brightness of adjacent first sub-pixels 240a at A₁. In another example, farther located first sub-pixels 240a, e.g., at A₂, may also be included in the average brightness determination for selecting the second sub-pixel 240b at B. Other arrangements are, however, not excluded. As shown in step S122, when the average brightness is lower than a preset value, then the corresponding second sub-pixel 240b is selected. The preset value, according to an aspect of the embodiment, for example, can be set as a 1/10 of a maximum brightness of a capability of the first sub-pixel 240a. When the average brightness is higher than or equal to the preset value, the second sub-pixel 240b is not selected, as shown in step S124.

Then, as shown in step S130, the selected second sub-pixels 240b are driven in the bright status. FIG. 4B illustrates the tilting direction of the liquid crystal molecules of the selected second sub-pixel when a control voltage is applied to the LCD apparatus. Referring to FIGS. 2B, 3B, and 4B together, when a control voltage is applied, the second active devices 246 of the selected second sub-pixels 240b as shown in FIG. 2A are turned on for conduction, and the liquid crystal molecules 410b corresponding to the selected second sub-pixel electrodes 248 which are electrically connected to the second active devices 246 are driven to tilt toward directions E and F. As such, the LCD apparatus 1000 leaks light in directions G and H. In other words, when viewing from directions G and H, the second sub-pixels 240b are in bright status. According to an aspect of the embodiment, the brightness of the selected second sub-pixels 240b driven to work in the bright status is enhanced to exceed an average brightness of the displayed image, so as to effectively disturb the image. According to an aspect of the embodiment, the brightness of the second sub-pixels 240b can be enhanced when the color filtering films, which are disposed on the opposite substrate 300, are not provided in regions corresponding to the second sub-pixels 240b.

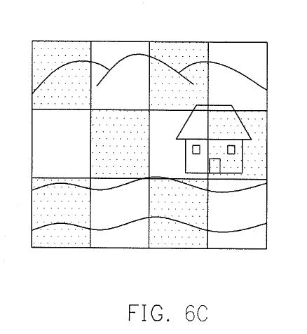

In the current embodiment, either all or some of the second sub-pixels 240b can be selected. FIG. 6A illustrates an image displayed by the LCD apparatus in the normal mode. FIG. 6B illustrates the image viewed by the viewer when all second sub-pixels are in a bright status. FIG. 6C illustrates the image viewed by the viewer when only some of the second sub-pixels are in the bright status. Comparing FIGS. 6A with 6B, it can be seen that when all second sub-pixels are driven in the bright status, what can be viewed by side viewers is an all-bright image. However, as shown in FIG. 6C, when only some of the second sub-pixels 240b are selected to be driven in the bright status, what can be viewed by side viewers is a unevenly mixed bright and dark image, which is more effective to prevent side viewers from peeping at the images displayed on the LCD apparatus 1000. According to an embodiment of the present invention, the second sub-pixels, where an average brightness of the adjacent first sub-pixels 240a is relative low, are driven in the bright status, and the second sub-pixels, where an average brightness of the adjacent first sub-pixels 240a is relative high, are maintained in the dark status. Thus, the images when viewed from the front appear very much different in brightness distribution from when viewed at an angle. In particular, the images viewed by side viewers will have enhanced brightness in areas which are intended to be dark in the normal image due to the bright status of the selected second sub-pixels 240b, so that the normally displayed images are effectively disturbed by the second sub-pixels 240b when viewed at an angle and thus achieving the anti-peep objective.

However, it should be noted that although the above embodiments are exemplified with bright status and dark status, the scope of the present invention is not limited thereto. For example, the selected second sub-pixels 240b may be driven to display different gray levels, rather than simply a bright status and a dark status, as illustrated and described herein. In other words, the second sub-pixels 240b can also be driven to display with a gray level between the maximum brightness and complete darkness. For example, when the LCD apparatus 1000 is determined to work in the narrow viewing angle display mode, those second sub-pixels 240b selected to be driven in bright status may display a brightness equivalent to that of the brightest one of all first sub-pixels 240a selected to be driven.

Further, the first sub-pixels 240a and the second sub-pixels 240b can be alternately arranged. It should be noted that the alternate arrangement hereby does not strictly restrict that each first sub-pixel 240a is completely surrounded by second sub-pixels 240b. The first sub-pixels 240a and the second sub-pixels 240b can be queued in a plurality of lines respectively and thereafter alternately arranged. Other similar arrangements may also be applied.

Further, each second sub-pixel 240b according to the embodiment of the present invention includes a second sub-pixel electrode 248 and a second active device 246. However, in other embodiments, the arrangement may be modified to that a single second active device 246 is disposed on the active device array substrate 200, and all second sub-pixel electrodes 248 are electrically connected to the second active device 246. In such an embodiment, all second sub-pixels will be selected to display in bright status at the same time. Alternatively, the arrangement may also be modified so that a plurality of second active devices 246 are electrically connected to respective second sub-pixel electrode(s) 248 so as to drive a plurality of second sub-pixels 240b in the bright status at the same time, while the rest second sub-pixels 240b remain in the dark status.

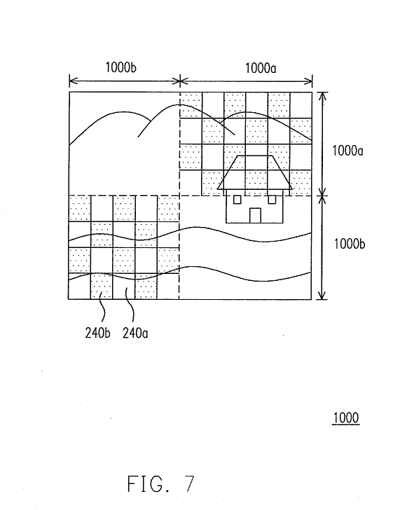

FIG. 7 is a schematic diagram illustrating the LCD apparatus being partitioned into a plurality of first regions 1000a and a plurality of second regions 1000b which are alternately arranged. Each of the first regions 1000a and the second regions 1000b includes a plurality of first sub-pixels 240a and a plurality of second sub-pixels 240b. According to an embodiment of the present invention, the method of partitioning the LCD apparatus 1000 includes arranging the first regions 1000a and the second regions 1000b into tessellations. However the arrangement of the first regions 1000a and the second regions 1000b can also be modified in other, suitable forms, such as arranging the first regions 1000a and the second regions 1000b into alternately distributed strips, or triangles. As exemplified in FIG. 7, the second sub-pixels 240b in the second regions 1000b are in dark status, and therefore images displayed by the first sub-pixels 240a in the second regions 1000b will not be disturbed when viewed at from the side at an angle. However, the second sub-pixels 240b in the first regions 1000a are driven in bright status, and therefore images displayed by the first sub-pixels 240a in the first regions 1000a are disturbed by the bright status of the corresponding second sub-pixels 240b when viewed from the side. Thus, anyone trying to peek at the images views only a confusing combination of normal images displayed by the second regions 1000b and disturbed images displayed by the first regions 1000a.

In summary, the present LCD apparatus and the method of driving the same selectively drives some or all of second sub-pixels to partially or wholly change brightness distribution of the images, so as to effectively disturb any one trying to peep at the displayed images at an oblique side viewing angle, and thus achieving the objective of anti-peep.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A method of driving an LCD apparatus, the LCD apparatus comprising a plurality of pixels, and each said pixel comprising a first sub-pixel and a second sub-pixel, the method comprising:
receiving a selecting signal determining the LCD apparatus to work in a narrow viewing angle display mode or a normal display mode;
when the LCD apparatus is determined to work in the normal display mode, driving the first sub-pixels to display images, and at the same time setting the second sub-pixels in a dark status; and
when the LCD apparatus is determined to work in the narrow viewing angle display mode, driving the first sub-pixels to display images, and at the same time selecting some of the second sub-pixels and driving the selected second sub-pixels to work in a bright status.

2. The method according to claim 1, wherein the selecting signal is inputted by a user, attached to an image signal, or generated according to a power supply status of the LCD apparatus or a sensing result of ambient factors.

3. The method according to claim 1, wherein
the LCD apparatus is partitioned into a plurality of first regions and a plurality of second regions, which are alternately arranged; and
the step of selecting and driving the selected second sub-pixels comprises driving the second sub-pixels located in the second regions to work in the bright status while keeping the second sub-pixels located in the first regions in the dark status.

4. The method according to claim 3, wherein in the LCD apparatus the first regions and the second regions are distributed in a tessellate form.

5. The method according to claim 1, wherein the step of selecting some of the second sub-pixels comprises:
calculating an average brightness of first sub-pixels which are adjacent to each of the second sub-pixels, and if the average brightness is lower than a preset value, selecting the second sub-pixel.

6. The method according to claim 5, wherein the preset value is 1/10 of a maximum brightness capable of being displayed by the first sub-pixels.

7. The method according to claim 1, further comprising:
when the LCD apparatus is working in the narrow viewing angle display mode, driving the selected second sub-pixels to work in the bright status, in which a brightness of the driven selected second sub-pixels is equal to the maximum displayable brightness of the first sub-pixels.

8. An LCD apparatus comprising:
an active device array substrate, comprising a substrate, and a plurality of scan lines, data lines, and pixels disposed on the substrate, each said pixel comprising a first sub-pixel and a second sub-pixel, and each first sub-pixel comprising a first active device and a first sub-pixel electrode electrically connected together, wherein each second sub-pixel comprises at least one second sub-pixel electrode, and at least one second active device disposed on the active device array substrate, and the second active device and the second sub-pixel electrode of the second sub-pixel are electrically connected together;
an opposite substrate, disposed on the active device array substrate;
a liquid crystal layer, disposed between the active device array substrate and the opposite substrate, the liquid crystal layer comprising liquid crystal molecules;
two polarizers, respectively disposed on the active device array substrate and the opposite substrate, respectively, wherein each polarizer has a transmission axis, and the two transmission axes of the two polarizers are perpendicular with one another, and
a control unit for, when the LCD apparatus is driven in a narrow viewing angle display mode, selecting some of the second sub-pixels and driving the selected second sub-pixels to work in a bright status, in which the liquid crystal molecules located in the selected second sub-pixels tilt in a direction parallel with one of the transmission axes of the two polarizers.

9. The LCD apparatus according to claim 8, wherein each of the first sub-pixels includes a first regional partition structure for orienting the liquid crystal molecules located in the first sub-pixels to tilt, when driven, in predetermined first directions.

10. The LCD apparatus according to claim 8, wherein an area of the first sub-pixel is different from that of the corresponding second sub-pixel.

11. The LCD apparatus according to claim 9, wherein each of the second sub-pixel electrodes further comprises a second region partition structure for orienting the liquid crystal molecules located in the second sub-pixels to tilt, when selected and driven, in predetermined second directions different from the first directions.

12. The LCD apparatus according to claim 11, wherein at least one of the first and second regional partition structures is a protrusion or a slit formed on the corresponding first or second sub-pixel electrode.

13. The LCD apparatus according to claim 11, wherein the first regional partition structure has a shape of an arrow head and the second regional partition structure is a straight strip elongated in the pointing direction of the arrow head.

14. A method of driving an LCD apparatus, the LCD apparatus comprising a plurality of pixels, and each said pixel comprising a first sub-pixel and a second sub-pixel, the method comprising:
receiving a selecting signal determining the LCD apparatus to work in a narrow viewing angle display mode or a normal display mode;
when the LCD apparatus is determined to work in the normal display mode, driving the first sub-pixels to display images, and at the same time deactivating the second sub-pixels; and
when the LCD apparatus is determined to work in the narrow viewing angle display mode, driving the first sub-pixels to display images, and at the same time selectively activating some, not all, of the second sub-pixels.

15. The method according to claim 14, wherein the activated second sub-pixels exhibit higher brightness than the deactivated second sub-pixels.

16. The method according to claim 15, wherein said some of the second sub-pixels are selectively activated based on brightness of the respective adjacent first sub-pixels.

17. The method according to claim 16, wherein said some of the second sub-pixels are selectively activated only in some, not all, display regions of the LCD apparatus.

18. An LCD apparatus, comprising:
a plurality of pixels, and each said pixel comprising a first sub-pixel and a second sub-pixel, and
a control unit adapted to drive the pixels according to the method of claim 14.
